(19) United States
(12) Patent Application Publication
(10) Pub. No.: US 2006/0210388 A1
(43) Pub. Date: Sep. 21, 2006

(54) Method of manipulating and assembling automotive frame, chassis, and body

(76) Inventors: Robert Giaier, Clarkston, MI (US); Michael Napior, Harrison Township, MI (US); Detlev Ziesel, Lake Orion, MI (US)

Correspondence Address: WOOD, HERRON & EVANS, LLP, 2700 CAREW TOWER, 441 VINE STREET, CINCINNATI, OH, 45202, US

(21) Appl. No.: 11/290,880

(22) Filed: Nov. 30, 2005

Related U.S. Application Data
(60) Provisional application No. 60/632,117, filed on Dec. 1, 2004.

(51) Int. Cl. A01D 90/08

(52) U.S. Cl. 414/802

(57) ABSTRACT

A method of manipulating an automotive vehicle frame having a longitudinal axis, a first generally upwardly directed side, and a second opposite generally downwardly directed side. The method comprises providing first and second robots, engaging a first end of the frame with the first robot, engaging a second end of the frame with the second robot, and rotating the frame about the longitudinal axis such that the second side is generally upwardly directed and the first side is generally downwardly directed.

### FIELD OF THE INVENTION

This invention relates generally to the automotive vehicle manufacturing industry, and more particularly to manipulating automotive frames, chassis, and bodies, and assembling chassis and bodies.

### BACKGROUND OF THE INVENTION

In the automotive vehicle manufacturing industry, it is customary to install various parts onto a vehicle frame to produce a vehicle chassis, and then “marry” the vehicle chassis to a vehicle body. The vehicle frame is first inverted or turned “upside down” so that certain suspension components such as front and rear upper and lower control arms, and knuckles with hubs, can be installed on the frame. Next the frame is turned “right side up” so that further parts such as the power train, brake lines, wiring harnesses, and wheels can be installed on the frame, thereby forming the chassis (sometimes also referred to as “chassis frame”).

Currently vehicle frames are rotated either by a servo-controlled gantry (a type of crane), or by a manually operated chain hoist.

It is desirable to eliminate the need for such gantries or hoists in the manipulation of vehicle frames.

One current technique of marrying chassis and bodies occurs with chassis and body moving on a conveyor. The body is conveyed overhead by a conveyor, and the chassis to be married to the body is supported by a moving lift machine that operates to move the chassis into position beneath the moving body while lifting the chassis into position for assembly with the body. Lift machines may employ different lift actuators to raise and lower the platform or support upon which the vehicle chassis is supported. For example, a hydraulic cylinder can be used as the lift actuator. U.S. Pat. No. 6,109,424, hereby incorporated by reference herein, discloses the use of a push chain as the lift actuator. And, U.S. Patent Application Publication No. US 2004/0007440 A1, also hereby incorporated by reference herein, discloses the use of a spiral lift as the lift actuator.

It is desirable to eliminate the need for such lift machines in the marrying of automotive chassis and bodies.

### SUMMARY OF THE INVENTION

In one aspect, the invention is a method of manipulating an automotive vehicle frame having a longitudinal axis, a first generally upwardly directed side, and a second opposite generally downwardly directed side. The method comprises providing first and second robots, engaging a first end of the frame with the first robot, engaging a second end of the frame with the second robot, and rotating the frame about the longitudinal axis such that the second side is generally upwardly directed and the first side is generally downwardly directed.

In another aspect, the invention is a method of manipulating an automotive vehicle frame having a longitudinal axis, a first generally upwardly directed side, and a second opposite generally downwardly directed side. The method comprises providing first and second stations, providing first and second robots, positioning the frame at the first station, engaging a first end of the frame with the first robot, engaging a second end of the frame with the second robot, rotating the frame about the longitudinal axis such that the second side is generally upwardly directed and the first side is generally downwardly directed, and translating the frame from the first station to the second station.

In yet another aspect, the invention is a method of assembling an automotive vehicle chassis and body. The method comprises providing first and second stations, providing first and second robots, positioning the chassis at the first station, positioning the body at the second station, engaging a first end of the body with the first robot, engaging a second end of the body with the second robot, and translating the body from the second station to the first station and placing the body atop the chassis.

In still another aspect, the invention is a method of manipulating an automotive vehicle frame, installing components on the frame to form a chassis, and assembling the chassis to a body. The method comprises providing first, second, and third stations, providing first and second pairs of robots, positioning the frame at the first station, installing suspension components on the frame, engaging a first end and a second end of the frame with the first pair of robots, rotating the frame about the longitudinal axis such that the second side is generally upwardly directed and the first side is generally downwardly directed, translating the frame from the first station to the second station, installing drive train components on the frame to form the chassis, positioning the body at the third station, engaging a first end and a second end of the body with the second pair of robots, and translating the body from the third station to the second station and placing the body atop the chassis.

A robot pair can be located between the stations that the pair moves a respective frame, chassis, or body to and from. The frame, chassis, body, and assembled chassis and body can be conveyed via conveyors. One or more of the robots can be equipped with machine vision to facilitate engaging a respective one of the frame, chassis, and body, and placing the body atop the chassis. One or more of the conveyors can be equipped with encoders to facilitate engaging a respective one of the frame, chassis, and body, and placing the body atop the chassis.

These and other features and advantages of the present invention will become more readily apparent during the following detailed description taken in conjunction with the drawings herein, in which:

### BRIEF DESCRIPTION OF THE DRAWINGS

FIG. 1 is a perspective view of an initial step in manipulating an automotive vehicle frame according to the present invention,

FIG. 2 is a view similar to FIG. 1 of an intermediate step in manipulating the frame,

FIG. 3 is a view similar to FIGS. 1 and 2 of a final step in manipulating the frame,

FIG. 4 is a perspective view of an initial step in assembling an automotive vehicle body and chassis,

FIG. 5 is a view similar to FIG. 4 of an intermediate step in assembling a body and chassis, and

FIG. 6 is a view similar to FIGS. 4 and 5 of a final step in assembling a body and chassis.

### DETAILED DESCRIPTION OF THE INVENTION

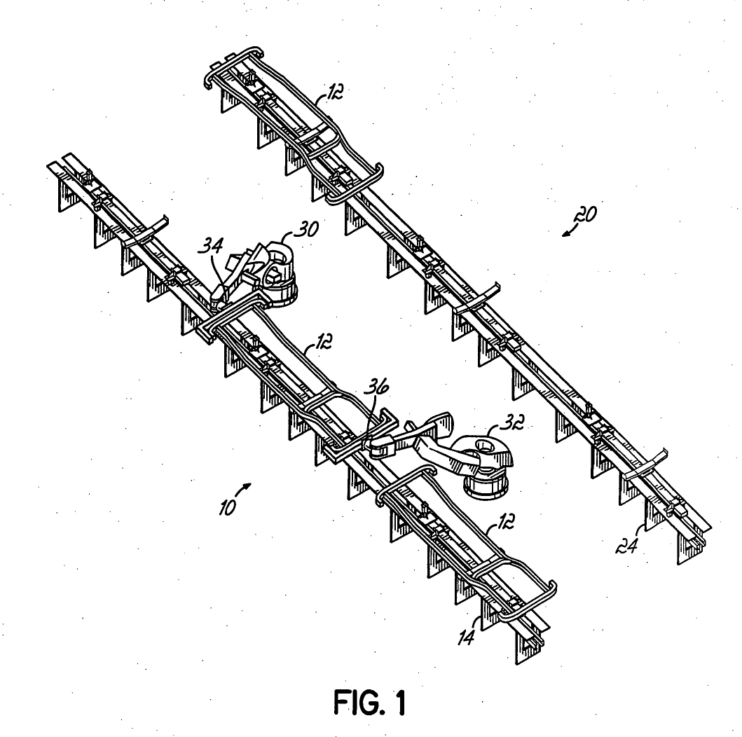

Referring first to FIG. 1, there is illustrated an initial step in manipulating an automotive vehicle frame in order to install parts thereon to form the chassis, according to the present invention. At a first station 10, frames 12 are supported upon a fixture 14, which fixture 14 can be any of the following types: inverted power and free conveyor, skillet conveyor, roller conveyor, chain conveyor, overhead conveyor, electrified monorail system, stationary table, etc. Frame 12 can be initially positioned upon fixture 12 right side up. A second station 20 can be positioned adjacent to first station 10 generally parallel thereto, and can include a similar fixture 24. A pair of robots 30, 32 can be positioned between stations 10 and 20. One of the robots 30, 32 can have its own processor/controller and the other of the robots 30, 32 can be slaved thereto. Or, each of the robots 30, 32 can have its own processor/controller. One type of robot 30, 32 which can be utilized to practice the invention is a KR-500 6-axis robot available from the assignee. The robots 30, 32 can incorporate end of arm tools or grippers 34, 36, respectively, for engaging the opposite ends of a frame 12. The robots 30, 32 can incorporate machine vision to enable them to engage the frame 12. In the alternative, or in addition thereto, the fixtures 14, 24 (if conveyors) can incorporate encoders to enable the robots 30, 32 to engage the frame 12. The machine vision and/or encoders provide appropriate feedback to the processor/controller(s), and suitable software running on the processor/controller(s) permits coordinated or synchronous motion of the robots 30, 32.

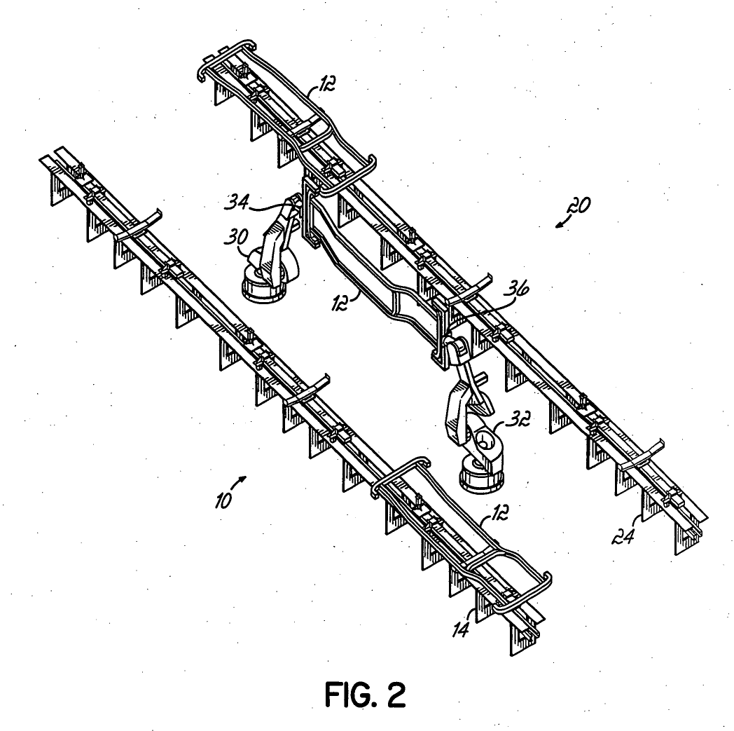

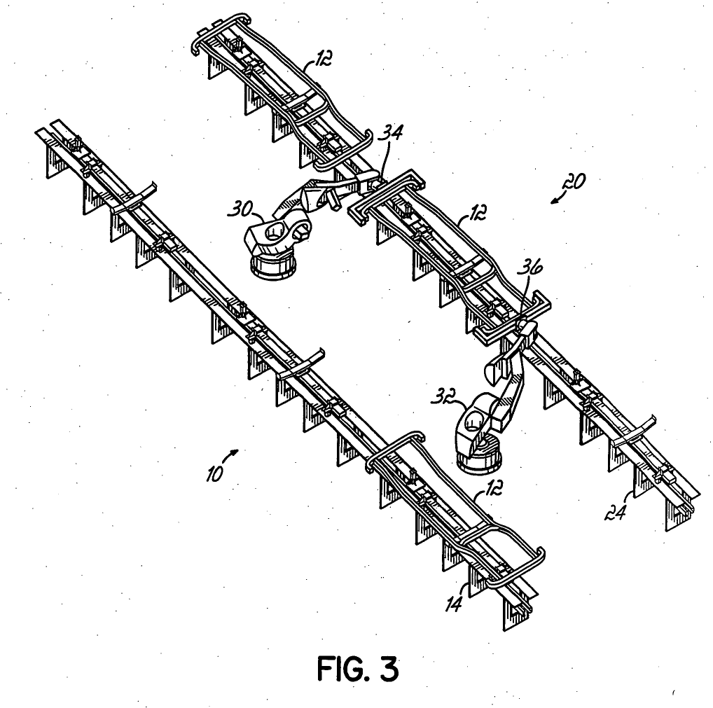

Referring now to FIGS. 1-3, robots 30, 32 engage the opposite ends of right side up frame 12, raise frame 12 off of fixture 14, rotate frame 12 approximately 180° about a longitudinal axis of frame 12, and place frame 12 up side down on fixture 24 of station 20. Suspension components, etc. are then installed on frame 12. Then the process is reversed, with the robots 30, 32 rotating frame 12 right side up and placing frame 12 back on station 10. Then the power train, etc. is then installed on the frame 12 to complete the chassis.

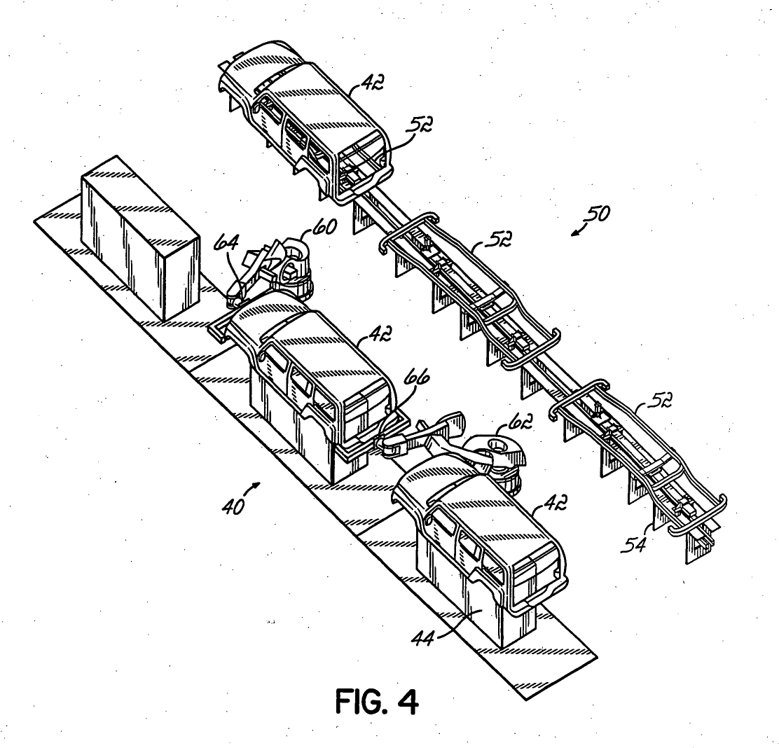

Referring now to FIG. 4, there is illustrated an initial step in marrying or “decking” an automotive vehicle chassis 52 with an automotive vehicle body 42 according to the present invention. At a first station 40, bodies 42 are supported upon a fixture 44, which fixture 44 can be any of the following types: inverted power and free conveyor, skillet conveyor, roller conveyor, chain conveyor, overhead conveyor, electrified monorail system, stationary table, etc. A second station 50 can be positioned adjacent to first station 40 and generally parallel thereto, and can include a fixture 54 supporting chassis 52 which are oriented right side up. A pair of robots 60, 62 can be positioned between stations 40 and 50. One of the robots 60, 62 can have its own processor/controller and the other of the robots 60, 62 can be slaved thereto. Or, each of the robots 60, 62 can have its own processor/controller. One type of robot 60, 62 which can be utilized to practice the invention is a KR-500 6-axis robot available from the assignee. The robots 60, 62 can incorporate end of arm tools or grippers 64, 66, respectively, for engaging the opposite ends of a body 42. The robots 60, 62 can incorporate machine vision to enable them to engage bodies 42 and place bodies 42 atop chassis 52. In the alternative, or in addition thereto, the fixtures 44, 54 (if conveyors) can incorporate encoders to enable the robots 60, 62 to engage the bodies 42 and place bodies 42 atop chassis 52. The machine vision and/or encoders provide appropriate feedback to the processor/controller(s), and suitable software running on the processor/controller(s) permits coordinated or synchronous motion of the robots 60, 62.

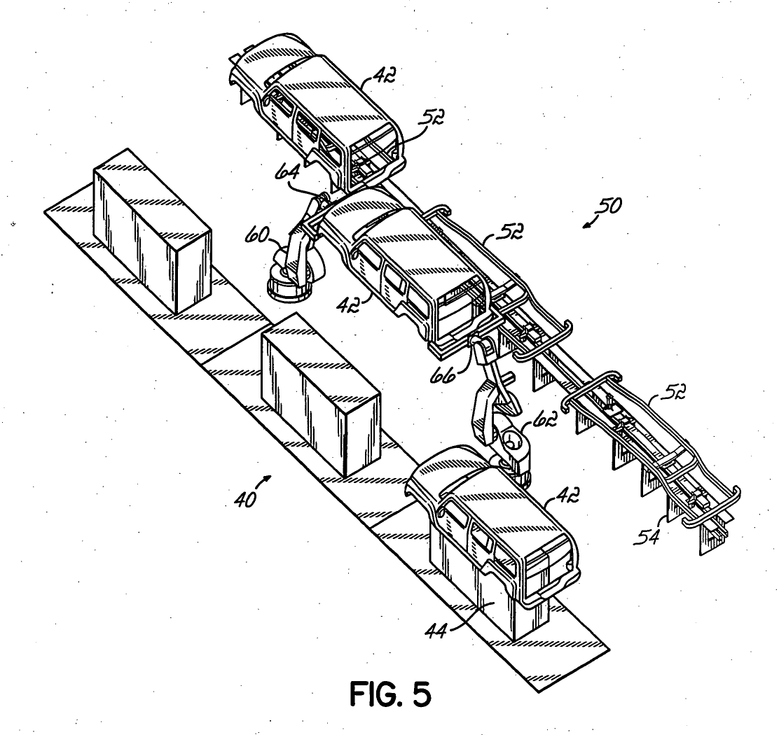

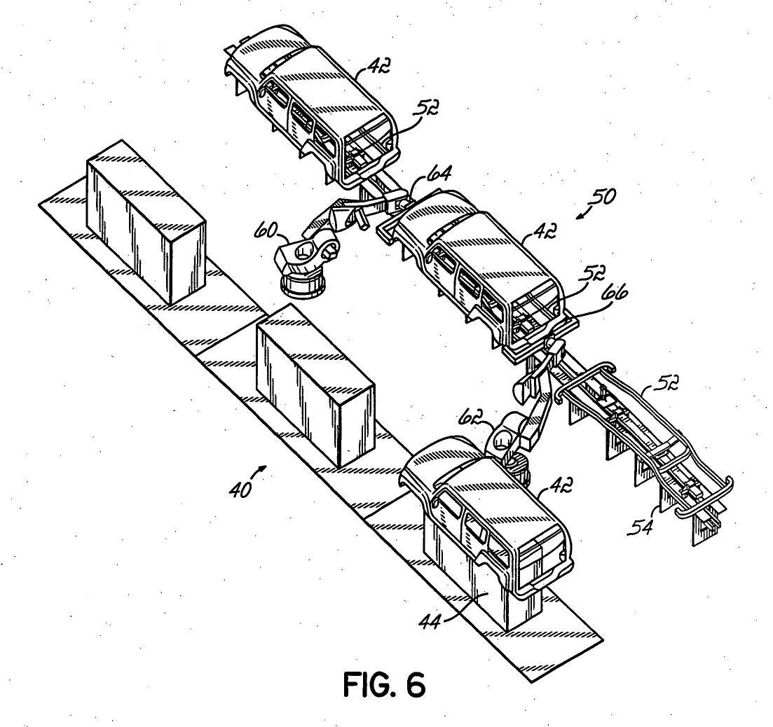

Referring now to FIGS. 4-6, robots 60, 62 engage the opposite ends of body 42, raise body 42 off of fixture 44, and place body 42 atop chassis 52 on fixture 54 of station 50.

The frames 12, chassis 52, and bodies 42 can be stationary or moving when engaged by the robots 30, 32 or 60, 62. The chassis 52 and bodies 42 can be stationary or moving when the body 42 is placed atop the chassis 52.

Those skilled in the art will readily recognize numerous adaptations and modifications which can be made to the present invention which will result in an improved method of manipulating and assembling automotive vehicle frames, chassis, and bodies, yet all of which will fall within the spirit and scope of the present invention as defined in the following claims. Accordingly, the invention is to be limited only by the scope of the following claims and their equivalents.

What is claimed is:

1. A method of manipulating an automotive vehicle frame: having a longitudinal axis, a first generally upwardly directed side, and a second opposite generally downwardly directed side, the method comprising:
providing first and second robots,
engaging a first end of the frame with the first robot,
engaging a second end of the frame with the second robot, and
rotating the frame about the longitudinal axis such that the second side is generally upwardly directed and the first side is generally downwardly directed.

2. The method of claim 1 wherein the frame is conveyed via a conveyor.

3. The method of claim 1 wherein at least one of the robots is equipped with machine vision to facilitate engaging the frame by the robots.

4. The method of claim 2 wherein the conveyor is equipped with an encoder to facilitate engaging the frame by the robots.

5. The method of claim 1 wherein suspension components are installed on the frame before the frame is rotated.

6. The method of claim 1 wherein power train components are installed on the frame after the frame is rotated.

7. The method of claim 1 wherein suspension components are installed on the frame after the frame is rotated.

8. The method of claim 9 wherein the frame is again rotated and then power train components are installed on the frame.

9. A method of manipulating an automotive vehicle frame having a longitudinal axis, a first generally upwardly directed side, and a second opposite generally downwardly directed side, the method comprising:
providing first and second stations,
providing first and second robots,
positioning the frame at the first station,
engaging a first end of the frame with the first robot,
engaging a second end of the frame with the second robot,
rotating the frame about the longitudinal axis such that the second side is generally upwardly directed and the first side is generally downwardly directed, and
translating the frame from the first station to the second station.

10. The method of claim 9 wherein the first and second robots are located between the first and second stations.

11. The method of claim 9 wherein the frame is conveyed to the first station via a conveyor.

12. The method of claim 9 wherein the frame is conveyed away from the second station via a conveyor.

13. The method of claim 9 wherein at least one of the robots is equipped with machine vision to facilitate engaging the frame by the robots.

14. The method of claim 11 wherein the conveyor is equipped with an encoder to facilitate engaging the frame by the robots.

15. The method of claim 9 wherein suspension components are installed on the frame before the frame is rotated.

16. The method of claim 9 wherein power train components are installed on the frame after the frame is rotated.

17. The method of claim 9 wherein suspension components are installed on the frame after the frame is rotated.

18. The method of claim 17 wherein the frame is again rotated and then power train components are installed on the frame.

19. A method of assembling an automotive vehicle chassis and body, the method comprising:
providing first and second stations,
providing first and second robots,
positioning the chassis at the first station,
positioning the body at the second station,
engaging a first end of the body with the first robot,
engaging a second end of the body with the second robot, and
translating the body from the second station to the first station and placing the body atop the chassis.

20. The method of claim 19 wherein the first and second robots are located between the first and second stations.

21. The method of claim 19 wherein the chassis is conveyed to the first station via a first conveyor and the body is conveyed to the second station via a second conveyor.

22. The method of claim 19 wherein at least one of the robots is equipped with machine vision to facilitate engaging the body by the robots and placing the body atop the chassis.

23. The method of claim 21 wherein the second conveyor is equipped with an encoder to facilitate engaging the body by the robots.

24. The method of claim 21 wherein the first conveyor is equipped with an encoder to facilitate placing the body atop the chassis.

25. A method of manipulating an automotive vehicle frame, installing components on the frame to form a chassis, and assembling the chassis to a body, the method comprising:
providing first, second, and third stations,
providing first and second pairs of robots,
positioning the frame at the first station,
installing suspension components on the frame,
engaging a first end and a second end of the frame with the first pair of robots,
rotating the frame about the longitudinal axis such that the second side is generally upwardly directed and the first side is generally downwardly directed,
translating the frame from the first station to the second station,
installing drive train components on the frame to form the chassis,
positioning the body at the third station,
engaging a first end and a second end of the body with the second pair of robots, and
translating the body from the third station to the second station and placing the body atop the chassis.

26. The method of claim 25 wherein the first pair of robots are located between the first and second stations and the second pair of robots are located between the second and third stations.

27. The method of claim 25 wherein the frame is conveyed to the first station via a first conveyor, the body is conveyed to the third station via a third conveyor, and the assembled chassis and body are conveyed away from the second station via a second conveyor.

28. The method of claim 25 wherein at least one of each pair of robots is equipped with machine vision to facilitate engaging a respective one of the chassis and body and placing the body atop the chassis.

29. The method of claim 27 wherein the third conveyor is equipped with an encoder to facilitate engaging the body by the second pair of robots.

30. The method of claim 27 wherein the first conveyor is equipped with an encoder to facilitate engaging the frame by the first pair of robots.

31. The method of claim 27 wherein the second conveyor is equipped with an encoder to facilitate placing the body atop the chassis.

32. The method of claim 27 wherein suspension components are installed on the frame before the frame is rotated.

33. The method of claim 27 wherein power train components are installed on the frame after the frame is rotated.

34. The method of claim 27 wherein suspension components are installed on the frame after the frame is rotated.

35. The method of claim 34 wherein the frame is again rotated and then power train components are installed on the frame.
